(19) United States
(12) Patent Application Publication
(10) Pub. No.: US 2024/0202096 A1
(43) Pub. Date: Jun. 20, 2024

(54) SYSTEMS AND METHODS RELATING TO PREDICTIVE ANALYTICS USING MULTIDIMENSIONAL EVENT REPRESENTATION IN CUSTOMER JOURNEYS

(71) Applicant: GENESYS CLOUD SERVICES, INC., MENLO PARK, CA (US)

(72) Inventors: ANKIT PAT, MARKHAM (CA); MACIEJ DABROWSKI, GALWAY (IE)

(73) Assignee: GENESYS CLOUD SERVICES, INC., MENLO PARK, CA (US)

(21) Appl. No.: 18/545,105

(22) Filed: Dec. 19, 2023

Related U.S. Application Data
(60) Provisional application No. 63/433,536, filed on Dec. 19, 2022.

(51) Int. Cl. G06F 11/34

(52) U.S. Cl. CPC G06F 11/3447; G06F 11/3438

(57) ABSTRACT

A method that includes the steps of: generating, via a training data process, training data samples from respective journey data samples, the journey data samples comprising a customer journey represented by a sequence of events, values associated with respective event attributes, and journey outcome; and training a machine learning model using the training data samples. The training data process includes generating a vector embedding for each of the events included within the journey data samples that captures the value for each of the event attributes by: dividing the list of event into low and high cardinality groups via a cardinality threshold; for the low cardinality groups, categorically encoding the values according to a total number of unique values appearing therein; for the high cardinality groups: clustering the values and categorically encoding the values according to the group it resides in.

### CROSS REFERENCE TO RELATED APPLICATION

This application claims the benefit of U.S. Provisional Patent Application No. 63/433,536, titled “Systems and Methods Relating to Predictive Analytics Using Multidimensional Event Representation in Customer Journeys”, filed in the U.S. Patent and Trademark Office on Dec. 19, 2022, the contents of which are incorporated herein.

### BACKGROUND

The present invention generally relates to customer relations services and customer relations management via contact centers and associated cloud-based systems, including delivering customer assistance via contact centers and internet-based service options. More particularly, but not by way of limitation, the present invention pertains to the interaction of web sites, mobile apps, analytics, and contact centers through the use of technologies such as predictive analytics and/or machine learning, including the use of representing customer journeys as a sequence of multidimensional events for enhanced performance.

### BRIEF DESCRIPTION OF THE INVENTION

The present invention includes a computer-implemented method the steps of: generating, via a training data process, training data samples from respective journey data samples, each of the journey data samples including a customer journey as represented by data describing a sequence of events, for each of the events, values associated with respective event attributes of a list of event attributes, and a journey outcome; and training a machine learning model using the generated training data samples. An input of the machine learning model, for each training data sample, includes a sequence of the vector embeddings generated via the training data process of the sequence of events; and an output of the machine learning model, for each training data sample, includes the associated journey outcome. The training data process includes generating a vector embedding for each of the events included within a given one of the journey data samples that captures the value for each of the event attributes by: dividing the event attributes of the list of event attributes into a low cardinality group and a high cardinality group, wherein the dividing is done according to whether the values included within the training data samples for a given event attribute has a cardinality above or below a predefined cardinality threshold; for each of the low cardinality groups, categorically encoding the values included within the low cardinality group according to a total number of unique values appearing therein; for each of the high cardinality groups: clustering the values included within the high cardinality group to create a plurality of cluster groups, and categorically encoding the values included within the high cardinality group according to the plurality of cluster groups in which the value resides; and deeming that each of the training data samples includes: the sequence of the vector embeddings generated from the sequence of events included in an associated one of the journey samples, and the journey outcome of the associated one of the journey samples.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is a simplified flow diagram demonstrating functionality of a machine learning model in accordance with embodiments of the present invention;

FIG. 4 is a schematic representation of a machine learning model in accordance with exemplary operation of embodiments of the present invention; and

FIG. 5 is a method in accordance with an embodiment of the present invention for generating training data for training a machine learning model.

### DETAILED DESCRIPTION

For the purpose of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as an apparatus, method, or computer program product. Example embodiments, thus, may take the form of a hardware embodiment, a software embodiment, or combination thereof.

### Computing Device

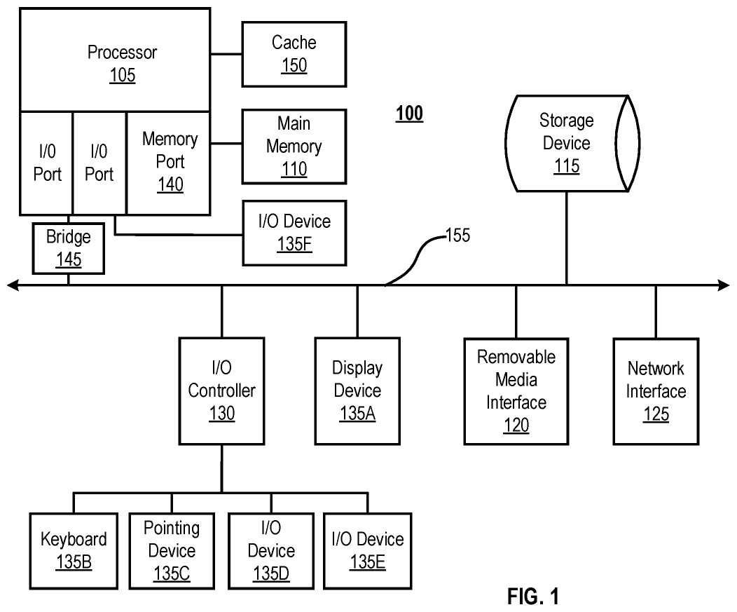

The present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced.

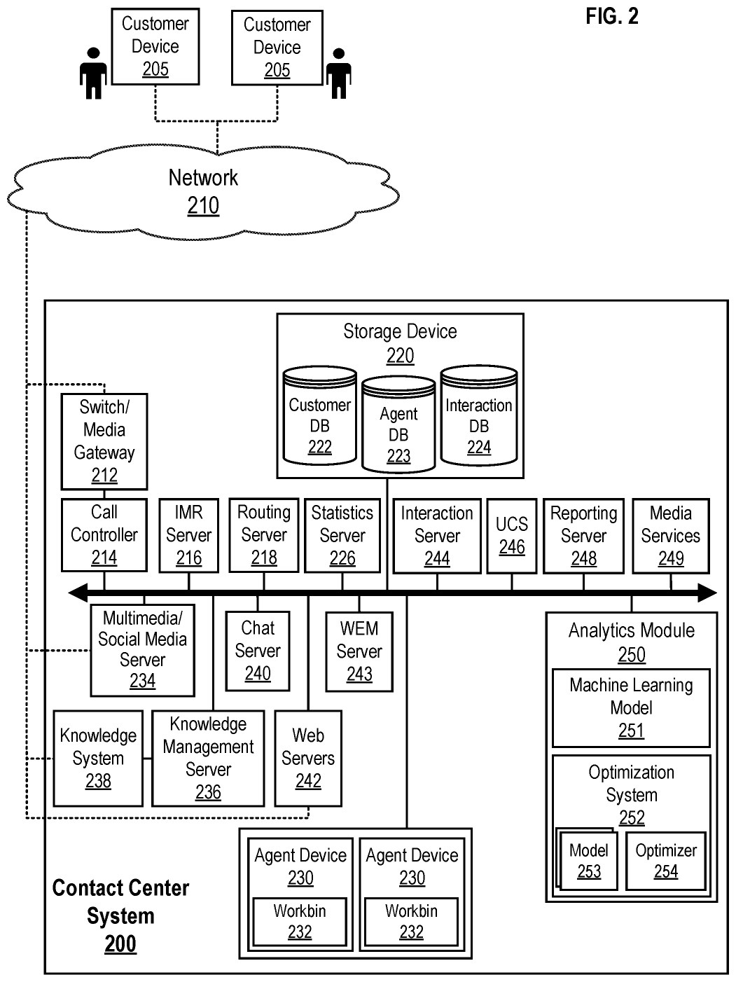

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as, for example, via voice (e.g., telephone calls or voice over IP or VoTP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “chatbots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment such as, for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing” or, simply, the “cloud” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, etc.) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VoIP calls), emails, voicemails, video, chat, screen-sharing, text messages, social media messages, WebRTC calls, etc. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, etc.) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VoIP calls, etc. The call controller 214 may include computer-telephone integration (CTI) software for interfacing with the switch/media gateway and other components. The call controller 214 may extract data about an incoming interaction, such as the customer's telephone number, IP address, or email address, and then communicate these with other contact center components in processing the interaction.

The interactive media response (IMR) server 216 enables self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices—represented generally by the storage device 220—for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VoIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, etc. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, etc.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more machine learning models, which may be based on neural networks. In certain embodiments, the machine learning model 251 is configured as a deep learning model, which is a type of machine learning based on neural networks in which multiple layers of processing are used to extract progressively higher level features from data. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

### Machine Learning Models

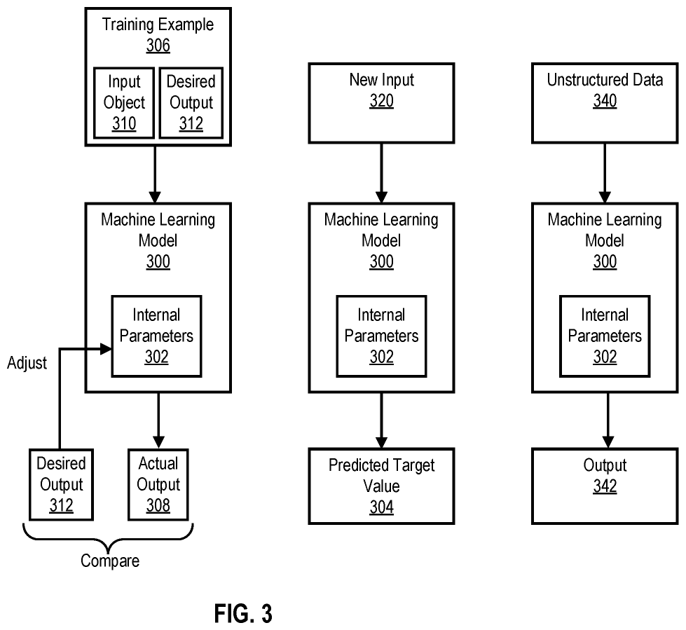

FIG. 3 illustrates an exemplary machine learning model 300, which may be included in one or more of the embodiments of the present invention. The machine learning model 300 may be a component, module, computer program, system, or algorithm. As described below, some embodiments herein use machine learning for providing predictive analytics for application in a contact center. Machine learning model 300 may be used as the model to power those embodiments. Machine learning model 300 is trained with training data samples 306, which may include an input object 310 and a desired output value 312. For example, the input object 310 and desired object value 312 may be tensors. A tensor is a matrix of n dimensions where n may be any of 0 (a constant), 1 (an array), 2 (a 2D matrix), 3, 4, or more.

The machine learning model 300 has internal parameters that determine its decision boundary and that determine the output that the machine learning model 300 produces. After each training iteration, which includes inputting the input object 310 of a training data sample into the machine learning model 300, the actual output 308 of the machine learning model 300 for the input object 310 is compared to the desired output value 312. One or more internal parameters 302 of the machine learning model 300 may be adjusted such that, upon running the machine learning model 300 with the new parameters, the produced output 308 will be closer to the desired output value 312. If the produced output 308 was already identical to the desired output value 312, then the internal parameters 302 of the machine learning model 300 may be adjusted to reinforce and strengthen those parameters that caused the correct output and reduce and weaken parameters that tended to move away from the correct output.

The machine learning model 300 output may be, for example, a numerical value in the case of regression or an identifier of a category in the case of classifier. A machine learning model trained to perform regression may be referred to as a regression model and a machine learning model trained to perform classification may be referred to as a classifier. The aspects of the input object that may be considered by the machine learning model 300 in making its decision may be referred to as features. After machine learning model 300 has been trained, a new, unseen input object 320 may be provided as input to the model 300. The machine learning model 300 then produces an output representing a predicted target value 304 for the new input object 320, based on its internal parameters 302 learned from training.

The machine learning model 300 may be, for example, a neural network, support vector machine (SVM), Bayesian network, logistic regression, logistic classification, decision tree, ensemble classifier, or other machine learning model. Machine learning model 300 may be supervised or unsupervised. In the unsupervised case, the machine learning model 300 may identify patterns in unstructured data 340 without training data samples 306. Unstructured data 340 is, for example, raw data upon which inference processes are desired to be performed. An unsupervised machine learning model may generate output 342 that includes data identifying structure or patterns.

The neural network may consist of a plurality of neural network nodes, where each node includes input values, a set of weights, and an activation function. The neural network node may calculate the activation function on the input values to produce an output value. The activation function may be a non-linear function computed on the weighted sum of the input values plus an optional constant. In some embodiments, the activation function is logistic, sigmoid, or a hyperbolic tangent function. Neural network nodes may be connected to each other such that the output of one node is the input of another node. Moreover, neural network nodes may be organized into layers, each layer including one or more nodes. An input layer may include the inputs to the neural network and an output layer may include the output of the neural network. A neural network may be trained and update its internal parameters, which include the weights of each neural network node, by using backpropagation.

In some embodiments, a convolutional neural network (CNN) may be used. A convolutional neural network is a type of neural network and machine learning model. A convolutional neural network may include one or more convolutional filters, also known as kernels, that operate on the outputs of the neural network layer that precede it and produce an output to be consumed by the neural network layer subsequent to it. A convolutional filter may have a window in which it operates. The window may be spatially local. A node of the preceding layer may be connected to a node in the current layer if the node of the preceding layer is within the window. If it is not within the window, then it is not connected. A convolutional neural network is one kind of locally connected neural network, which is a neural network where neural network nodes are connected to nodes of a preceding layer that are within a spatially local area. Moreover, a convolutional neural network is one kind of sparsely connected neural network, which is a neural network where most of the nodes of each hidden layer are connected to fewer than half of the nodes in the subsequent layer. In other embodiments, a recurrent neural network (RNN) may be used. A recurrent neural network is another type of neural network and machine learning model. A recurrent neural network includes at least one back loop, where the output of at least one neural network node is input into a neural network node of a prior layer. The recurrent neural network maintains state between iterations, such as in the form of a tensor. The state is updated at each iteration, and the state tensor is passed as input to the recurrent neural network at the new iteration. In still other embodiments, the recurrent neural network is a long short-term memory (LSTM) neural network. In some embodiments, the recurrent neural network is a bi-directional LSTM neural network. A feed forward neural network is another type of a neural network and has no back loops. In some embodiments, a feed forward neural network may be densely connected, meaning that most of the neural network nodes in each layer are connected to most of the neural network nodes in the subsequent layer. In some embodiments, the feed forward neural network is a fully-connected neural network, where each of the neural network nodes is connected to each neural network node in the subsequent layer. A gated graph sequence neural network (GGSNN) is a type of neural network that may be used in some embodiments. In a GGSNN, the input data is a graph, comprising nodes and edges between the nodes, and the neural network outputs a graph. The graph may be directed or undirected. A propagation step is performed to compute node representations for each node, where node representations may be based on features of the node. An output model maps from node representations and corresponding labels to an output for each node. The output model is defined per node and is a differentiable function that maps to an output. Further, embodiments may include neural networks of different types or the same type that are linked together into a sequential or parallel series of neural networks, where subsequent neural networks accept as input the output of one or more preceding neural networks. The combination of multiple neural networks may be trained from end-to-end using backpropagation from the last neural network through the first neural network. As stated, the machine learning model 251 may also be configured as a deep learning model. The deep learning model is type of machine learning based on neural networks in which multiple layers of processing are used to extract progressively higher level features from data. Deep learning models are generally more adept at unsupervised learning.

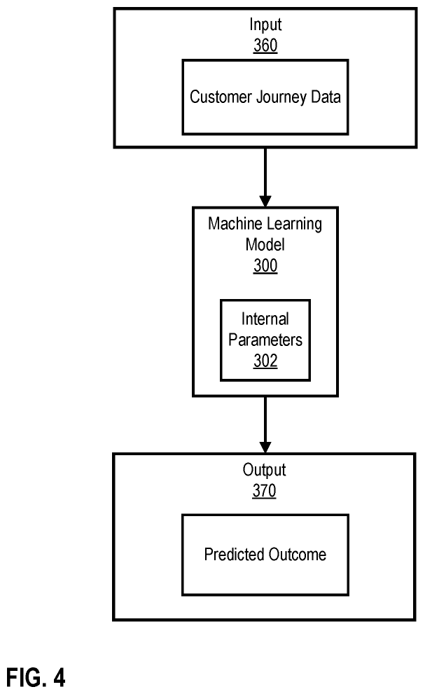

FIG. 4 illustrates use of the machine learning model 300 to perform inference on input 360 comprising data relevant customer journeys. For example, as discussed below, input 360 may include customer journey data, i.e., a sequence of multidimensional vector embeddings generated to represent a sequence of web events that describes a customer journey. The machine learning model 300 then performs inference on the data based on its internal parameters 302 that are learned through training. The machine learning model 300 generates an output 370 of a predicted outcome. In exemplary embodiment, the machine learning model 300 may be configured according to desirability of particular machine learning algorithms for achieving the functionality described herein. As an example, the machine learning model 300 may include one or more neural networks. More specifically, the machine learning model 300 may include a recurrent neural networks (RNNs), which are generally effective for processing sequential data, such as text, audio, or time series data. Such models are designed to remember or “store” information from previous inputs, which allows them to make use of context and dependencies between time steps. This makes them useful for tasks such as language translation, speech recognition, and time series forecasting. In some embodiments, the RNN may include long short-term memory (LSTM) networks or gated recurrent units (GRUs). Both LSTMs and GRUs are designed to address the problem of “vanishing gradients” in RNNs, which occurs when the gradients of the weights in the network become very small and the network has difficulty learning. LSTM networks are a type of RNN that use a special type of memory cell to store and output information. These memory cells are designed to remember information for long periods of time, and they do this by using a set of “gates” that control the flow of information into and out of the cell. The gates in an LSTM network are controlled by sigmoid activation functions, which output values between 0 and 1. The gates allow the network to selectively store or forget information, depending on the values of the inputs and the previous state of the cell. GRUs, on the other hand, are a simplified version of LSTMs that use a single “update gate” to control the flow of information into the memory cell, rather than the three gates used in LSTMs. This makes GRUs easier to train and faster to run than LSTMs, but they may not be as effective at storing and accessing long-term dependencies. In other embodiments, the machine learning model 520 may be configured as a sequence to sequence model comprising a first encoder model and a decoder model. The first encoder may include a RNN, or convolutional neural network (CNN), or another machine learning model capable of accepting sequence input. The decoder may include a RNN, CNN, or another machine learning model capable of generating sequence output. The sequence to sequence model may be trained on training data samples, wherein each training data sample includes a sequence of vector embeddings representing a sequence of customer journey events and a journey outcome. For example, the sequence to sequence model may be trained by inputting the input data to the first encoder model to create a first embedding vector. The first embedding vector may be input to the decoder model to create an output result of a predicted outcome. The output result may be compared to the actual outcome, and the parameters of the first encoder and the decoder may be adjusted to reduce the difference between the predicted outcome and the actual outcome. The parameters may be adjusted through backpropagation. In an embodiment, the sequence to sequence model may include a second encoder which takes in additional information related to the failed test/breaking change to create a second embedding vector. The first embedding vector may be combined with the second embedding vector as input to the decoder. For example, the first and second embedding vectors may be combined using concatenation, addition, multiplication, or another function. In another example, the features may include statistics computed on the count and order of words or characters in the data associated with particular event features, for example, words associated with a page-URL. In other embodiments, the machine learning model for outputting a predicted outcome may be an unsupervised model, such as a deep learning model. The unsupervised model is not trained and instead identifies its predictions based on identification of patterns in the data. In an embodiment, the unsupervised machine learning model may identify common features in the training dataset.

### Multidimensional Event Representation for Predictive Analytics

Deriving actionable insights from customer journeys has been a critical area of research focus over the last few years. It is understood that being able to generate a succinct visualization of such journeys is an important step toward better understanding the patterns found within customer journeys. Doing this for events occurring as customers interact with websites-which may be referred to as “web events” or simply “events”—is exceedingly difficult given the lack of structure as to how such interactions unfolds. As will be seen, the present invention provides a way to model customer journeys so to identify milestone events that correlate to particular outcomes. The milestone events can then be used to produce instructive visualizations in relation to the predictive sequences of such web events found in customer journeys. Further, through an iterative process enabled by the present invention, the predictive ability and accuracy of customer journey models based on web events can be significantly enhanced, as noisy events/parameters are identified and removed. These enhanced models can then be used to provide more accurate visualizations as well as provide effective next best action recommendations.

More generally, a customer journey, as used herein, refers to a sequence of events occurring when a customer interacts with an enterprise or business. This may include a customer interacting with automated systems, for example, a virtual agent/bot or IVR system. As stated above, this may further include how a customer interacts with a website of a business. Customer journeys may be used as a way to organize information about the way customers interact with businesses over time. Customer journeys are discrete, unevenly sampled time series of customer events that contain a heterogeneous set of attributes and features. They may contain both unambiguous signals of commitment—like buying a new car—as well as more ambiguous signals of commitment, such as a monthly series of credit card purchases or contact with customer service. The use of the customer journey framework has been observed to improve machine learning performance whether for recommendation systems or the customization of experience. Customer journeys can then be used to drive sales through those recommendations and customized experiences. With the use of customer journeys, customer experience may be treated as a dynamic rather than a static factor. Thus, for example, customer experience becomes a continuously managed signal or parameter that can be used to decide, recommend, and trigger activities from a business to its customers and prospective customers. Modeling, for example, in program state of a machine-learning or operational research application, of customer joumeys is utilized to determine a data point, such as a new event or events, that minimizes a knowledge gap in the customer's journey. These outcomes may be modeled to determine a “next best action” for a business to take in relation to a customer that is either likely to produce a desired result, such as make a sale, or avoid an undesirable result, such as a customer discontinuing service.

Much progress has been made in relation to the effective use of certain types of customer journeys. These include those types of customer journeys that are more structured as to how customers are permitted to navigate through them, for example, customer journeys involving interactions with agent bots, which may be referred to as blot flows, and those in relation to interactions with IVR systems, which may be referred to IVR pathways or journeys. Beyond that, however, there remains much need for similar support is relation to those customer journeys describing how customers interact with websites. Advances in this area have proved to be a difficult challenge. A primary reason for this is that, while botflows and IVR pathways have a fixed structure of how events may be sequenced within any given customer journey, the manner in which a customer interacts with a website does not. This lack of structure leads to a multitude of variations in possible event sequences (i.e., the ordering of events in customer journeys). As an example, the use of trie data structures have been productive in modeling botflows and IVR pathways for predictive purposes and to generate useful visualizations, but this usefulness has not extended to customer journeys involving web events. One reason for this is that the inherent characteristics of trie data structures make scaling for this for this type of use-case nearly impossible. With trie data structures, a new branch is created for every new prefix (of event sequences), which in turn leads to the creation of a very large and cumbersome trie data structure. The trie data structure quickly grows in size with even slight variations in starting events or event sequence, which leads to significant increase in memory usage and processing time that make it not feasible.

Events occurring when interacting with websites are generally multidimensional, i.e., the events contains many different attributes, and this adds to difficulties in deciphering customer journeys in this area. To handle such complex cases of high variations in event sequences, or to account for multiple attributes (i.e., dimensions) of events while mining for patterns for prediction or visualization purposes, a trie data structure just does not work. Instead more advanced machine learning algorithms (specifically sequence learning algorithms) have been found to be more effective, as proposed in this disclosure. Such large variations in sequences come with the problem of noisy visualization, wherein identifying which events are important for visualization becomes critical. Embodiments of the present invention provide a solution to these several challenges.

Turning now to particular embodiments, it will be appreciated that discovering patterns or common paths in customer journeys is extremely valuable for businesses, as this allows the businesses to make predictions that optimize customer experience and business KPIs. However, as will be appreciated, events in a customer journey do not carry equal importance. (Note that reference events includes reference to web events or events.) Thus, to identify common patterns in customer journeys, it is vital to remove unimportant events (noise) and focus on only the important events (milestone events) that lead to achieving an outcome and have predictive value. Such milestone events are events upon which accurate predictions can be made about a customer's next actions, wants, or needs. Of course, differentiating between these two types of events is often difficult, which contributes to the challenges around customer journey analytics, particularly in relation to complex interactions involving a website.

When customer journey events are multi-dimensional, i.e., each event has several different attributes, current techniques for discovering milestones and patterns in journeys simply do not perform well. This is particularly true when these event attributes have a high degree of cardinality.

When customer journeys map interactions with a business website, each of the events may be scored in relation to several different types of event attributes. For example, in this context, events generally involve a customer moving between different webpages of a website, submitting searches, or interacting with aspects of one of the page, with the possible event attributes describing these actions including what may be a lengthy list. For example, event attributes may include characteristics describing the website, the page being visited, an order of pages visited, searches strings, referring websites, as well as many others. Preferred embodiments of the present invention may include a list of events attributes that is used to describe attributes associated with each events, which may include webpage or page attributes, customer attributes, location attributes, date attributes, attributes of referring websites, number of events attributes, browser attributes, session attributes, user device attributes, query or search attributes, as well as others. These attributes may be determined in relation to each web event occurring within a customer journey, for example in relation to each webpage visited, widget interacted with, search entered, etc. that occurs when a customer is interacting with a particular website. According to an exemplary embodiment, a list of event attributes may include each of the following or a subset therof: geolocation_country; geolocation_locality; geolocation_regionName; visit_date; referrer_domain; session_referrer_url; referrer_keywords; ipAddress; visitReferrer_domain; referrer_name; visitReferrer_pathname; visitReferrer_medium; referrer_pathname; total_EventCount; session_referrer_queryString; session_referrer_hostname; referrer_hostname; browser_fingerprint; browser_featuresWebrtc; browser_viewheight; browser_featuresFlash; session_shortId; browser_featuresJava; browser_lang; device_category; device_screenheight; device_osVersion; page_domain; page_URL; totalPageviewCount; page_lang; session_type; session_pageviewCount; customerIdType; loginId; customerId; session_eventCount; device_type; page_breadcrumb; visitId; session_createdDate; device_isMobile; session_referrer_pathname; session_referrer_fragment; device_osFamily; ipOrganization; mktCampaign_content; outcomeName; visitReferrer_name; browser_family; marketingCampaign_source; referrer_queryString; outcomeId; referrer_url; browser_version; geolocation_longitude; session_id; referrer_fragment; browser_viewWidth; session_secondsSincePrevious; searchQuery; device_fingerprint; session_secondsSinceFirst; session_durationInSeconds; visitReferrer_url; page_title; session_referrer_name; visitReferrer_hostname; geolocation_timezone; geolocation_postalCode; externalContactId; mktCampaign_clickId; page_fragment; geolocation_source; geolocation_latitude; visitReferrer_keywords; page_keywords; page_queryString; session_referrer_keywords; userAgentString; referrer_medium; page_hostname; page_pathname; organizationId; and visitReferrer_fragment.

In accordance with exemplary embodiments, vector embeddings for each event (i.e., web event) are generated that capture, (i.e., mathematically take into account or reflect) data describing the scores or values for the given event for each of the event attributes. The generation of such vector embeddings may be done in the following way.

First, low-cardinality event attributes are categorically encoded. In such cases, low cardinality may be defined as cardinality below a chosen threshold, for example, 10. As an example, the country that the customer is located in (e.g., “geolocation_country”) may be one of the event attributes having a low cardinality. So, for example, if there are five unique countries that appear as a value in this event attribute, each country may be enumerated as 1, 2, 3, 4, 5, and then normalized, with this forming the basis for the embedding vector.

In accordance with exemplary embodiments, another process may be used to handle event attributes having a high cardinality. For event attributes having a high cardinality, the unique values may first be clustered. For example, event attributes associated with page-URLs may have a high cardinality, as names of page-URLs are unique. In exemplary embodiments, to perform the clustering, features would need to be first extracted from the page-URLs. For example, this may include removing special characters so that a string of words remains. Then, for example, a separate vector embedding could be created for each page-URL. This may be done via a trained machine learning model configured for this purpose, as one of ordinary skill in the art will appreciate. Vector embeddings are created through a machine learning process where a model is trained to convert particular kinds of data into numerical vectors. Another machine learning model (which is trained to perform clustering) could then be used to cluster the vector embedding based on their similarities. For example, neural network-based clustering may be used. This type of clustering uses neural networks to learn the cluster structure of the data. Examples of this method are autoencoders and deep embedding clustering. Other types of clustering algorithms may also be used, for example, centroid-based clustering (which uses the mean or median of a cluster's points as the cluster's center or centroid), K-means (most popular centroid-based clustering algorithm); hierarchical clustering (which builds a hierarchy of clusters, where each cluster is a subset of the next higher-level cluster), density-based clustering (which groups together points that are close to each other in the feature space), such as DBSCAN, and distribution-based clustering (models the data as a mixture of probability distributions) such as Gaussian mixture model (GMM), and spectral clustering (uses the eigenvectors of a similarity matrix to cluster the data).

For example, in an exemplary embodiment, the words appearing in a given page-URL value could be treated like NLP words. That is, after removing special characters, the remaining works could be used to generate a vector embedding, which would then be used to cluster similar page-URLs. The clustering process may be used to drastically reduce the cardinality appearing in values of the event attribute. For example, in the example of the page-URL, each can now be represented in relation to its cluster, which forms the bases of vector embedding.

At this point, the question may be asked as to why categorical encodings are not generated for all event attributes and then cluster the multi-dimensional vectorized events. The reason for this is that the result would yield a single cluster number for each event, and hence represent a journey as a single dimensional sequence. This would limit the effectiveness of associated predictive analytics. The reason as to why this is not done also has to do with explainability. Although clustering the events as a whole generates single dimensional journey sequences, it offers no explanation as to the properties of those clusters. Therefore, any results obtained from path analysis and milestone events will be at the level of “cluster numbers” and, thus, not be interpretable in a meaningful way.

With the first two steps completed, the customer journey can then be represented as a sequence of events. Specifically, the customer journey is represented as the sequence of vector embeddings, as obtained above, for the sequence of respective events. Each event in the journey is transformed into a vector embedding that captures the values that the event had in each event attribute of the list of event attributes. In accordance with exemplary embodiments, this sequence of vector embeddings constitutes the input for training a prediction model. As for the output, this may be based on whether or not a target outcome was achieved in each particular customer journey. For example, the target outcome (or outcome) could be whether a sale was achieved or not achieved. Or, for example, the outcome could be whether the website interaction resulted in the customer accepting an offered chat session with a live agent. In exemplary embodiments, the output may be represented using a binary variable, such as “0” for the outcome not being achieved and a “1” for the outcome being achieved. As will be appreciated, the output represents the target variable for training the prediction model.

In accordance with exemplary embodiments, the prediction model is then trained using the vector embeddings and the outcome data. For example, the model may be an Attention-based Bidirectional LSTM model or a transformer model. As will be appreciated, this model is trained to predict output given an input and is selected in accordance with its ability to handle low cardinality multi-dimensional events embeddings, the generation of which was described above.

In an alternative embodiment, each tuple of multi-dimensional event embedding can be categorically encoded to generate single dimensional journeys. For example, an event E1=(a1, a2, a3, a4, a5), E2=(b1, b2, b3, b4, b5), E3=(c1, c2, c3, c4, c5). Then E1 can categorically encoded as 1, E2 as 2 and E3 as 3. The cardinality of this categorical encoding will be equal to the product of cardinalities of individual event attributes. The categorical encoding can be done in the fashion (without overly increasing cardinality) as steps have been taken during the embedding process to convert high cardinality event attributes to low cardinality representations using clustering.

As a final step, after the model is trained, the attention scores may be calculated for certain of the events appearing in selected customer journeys. Such customer journeys may be selected as those cases where the trained model is successful at predicting the outcome. Such cases may be selected from the training dataset and/or include new cases where the model prediction is accurate. The attention scores then may be compared to an attention score threshold, with each of the events yielding attention scores higher than the threshold being identified as milestone events. Each of the events having an attention score lower than the selected threshold may be treated as noise and ignored. This may be repeated across many such test cases to determine the events that most regularly appear as milestone events. Customer journeys for website interactions then may be represented as a sequence of such milestone events. As will be appreciated, such milestone events may be used to generate succinct and informative visualizations of particular types of customer journeys taken in relation to a businesses website. In exemplary embodiments, the visualization may include volume and direction of traffic from one milestone event to another, similar to weighted directed graph.

As an additional step, high attention scores may be correlated with particular event attributes present in the milestone events. This provides a key to understanding which of the event attributes making up the multidimensional vectors of the events are more important in determining outcomes. With this done, additional explainability is provided. This additional information can then be used for additional predictive insights, including “next best action” recommendations. Further, via an iterative process, the list of event attributes may be reduced in length, as certain ones are found to be predictive (or important to why an event is identified as a milestone event) and others found to only add noise. More accurate models can then be trained by focusing on fewer event attributes that are found to correlate strongly with certain outcomes, while discarding the event attributes that are found to be uncorrelated noise.

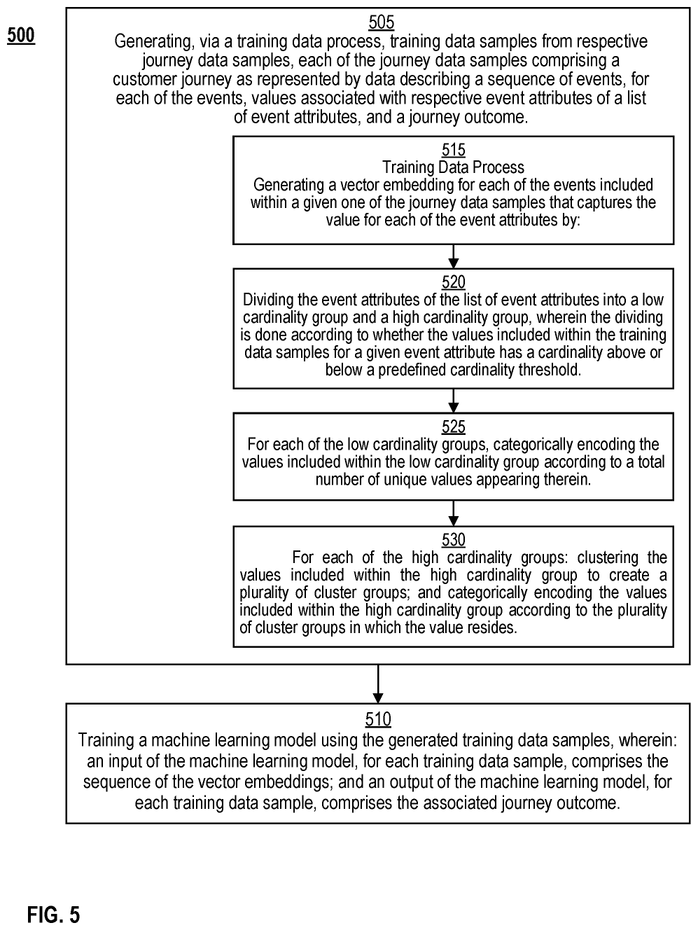

With reference now to FIG. 5, an exemplary method 500 is shown that illustrates an embodiment of the present invention. The method 500 begins, at step 505, by generating, via a training data process (which is shown as an insert to step 505), training data samples from respective journey data samples, each of the journey data samples including a customer journey as represented by data describing a sequence of events, for each of the events, values associated with respective event attributes of a list of event attributes, and a journey outcome. At step 510, the method 500 continues by training a machine learning model using the generated training data samples from the previous step. In training, an input of the machine learning model, for each training data sample, includes a sequence of the vector embeddings generated via the training data process of the sequence of events; and an output of the machine learning model, for each training data sample, includes the associated journey outcome.

In regard to the training data process, as shown, the process may begin at step 515 by generating a vector embedding for each of the events included within a given one of the journey data samples that captures the value for each of the event attributes. At steps 520, 525, and 520, the steps by which the training data process generates the vector embeddings are described. At step 520, the training data process includes dividing the event attributes of the list of event attributes into a low cardinality group and a high cardinality group, wherein the dividing is done according to whether the values included within the training data samples for a given event attribute has a cardinality above or below a predefined cardinality threshold. At step 520, the training data process includes, for each of the low cardinality groups, categorically encoding the values included within the low cardinality group according to a total number of unique values appearing therein. At step 520, the training data process includes, for each of the high cardinality groups, clustering the values included within the high cardinality group to create a plurality of cluster groups; and categorically encoding the values included within the high cardinality group according to the plurality of cluster groups in which the value resides. Thus, the training data samples each includes a sequence of the vector embeddings generated from the sequence of events included in an associated one of the journey samples; and the journey outcome of the associated one of the journey samples.

In exemplary embodiments, the events are web events. Each web event may include actions taken by a customer as the customer interacts with a website of a business, such as, actions related to selecting particular webpages of the website for browsing and submitting a search query.

In exemplary embodiments, when described in relation to a first training data sample, which is representative of how each of the training data samples are used to train the machine learning model, the step of training the machine learning model may include: providing as input to the machine learning model the sequence of vector embeddings generated for the first training data sample; generating as output of the machine learning model a predicted journey outcome; comparing the journey outcome of the first training data sample to the predicted journey outcome and, via the comparison, determining a difference therebetween; and adjusting parameters of the machine learning model to reduce the determined difference.

In exemplary embodiments, the journey outcome may include data indicating whether a binary condition is achieved or not achieved. The binary condition may relate to a performance metric of the business, for example, whether a sale is made or a performance metric is satisfied.

In exemplary embodiments, the event attributes may include: multiple attributes describing the webpage being browsed by the customer, including at least a URL address and keywords associated therewith; multiple attributes describing the customer, including at least a customer identifier, a location of the customer, and an attribute describing a device of the customer; multiple attributes describing a referring website, including at least key words associated with the referring website; at least one attribute describing a search query submitted by the customer on the referring website or the website of the business; and at least one attribute describing a total number of events in a browsing session.

In exemplary embodiments, one or more other trained machine learning models may be used in the step of clustering the values included within each of the high cardinality groups. This step may further include: extracting features from the values included within the high cardinality group; generating a vector embedding for the extracted features for each of the values; and clustering according to similarities found in the generated vector embeddings.

In exemplary embodiments, the machine learning model is a transformer model. In other embodiments, the machine learning model is an attention-based bidirectional long short-term memory recurrent neural network that calculates attention scores for respective events included within a customer journey when predicting a journey outcome. In exemplary embodiments, the method may further include the step of determining milestone events by: receiving an attention score threshold; receiving a subset of training data samples, the subset of training data samples includes training data samples in which the trained machine learning model accurately predicts whether the binary condition is achieved or not achieved; determining the attention scores for the events included within each of the training date samples of the subset of training data samples; for each of the events, comparing the attention scores to the attention score threshold; determining whether each of the events is a milestone event based on whether the attention score for the event exceeds the attention score threshold; and identifying a customer journey type as being a sequence of the determined milestone events.

In exemplary embodiments, the method may further include the step of generating a visual representation of the identified customer journey type. The visual representation may include a sequence of connected nodes where each of the nodes is labeled as being one of the milestone events of the customer journey type. In exemplary embodiments, the generated visual representation includes volume and direction of traffic label from one of the milestone events to another of the milestone events. This may be in the form of an number labeling the connector for the volume and the connector being formed as an arrow for direction. In exemplary embodiments, the step of receiving the attention score threshold includes receiving a plurality of different attention score thresholds so to generate a plurality of respective customer journey types, the plurality of customer journey types having varying number of the identified milestone events in accordance with the plurality of different attention score thresholds. The method may include the step of generating the visual representations of each of the plural of customer journey types.

In exemplary embodiments, the method may further include the step of correlating high attention scores achieved in determining the milestone events with one or more particular event attributes present in the milestone events. In exemplary embodiments, the method may further include the step outputting one or more recommendations regarding actions to take with a future customer interacting with the website of the business when the one or more particular event attributes are detected as being present during the interaction with the future customer. Such recommendations may be performed in real time in response to live interactions and/or executed automatically. In exemplary embodiments, the method may further include the steps of: determining one or more other particular event attributes that is noise based on a low correlation in determining the milestone events; and outputting one or more recommendations regarding removing the one or more other particular event attributes when training a revised version of the machine learning model.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A computer-implemented method comprising the steps of:
generating, via a training data process, training data samples from respective journey data samples, each of the journey data samples comprising a customer journey as represented by data describing:
a sequence of events;
for each of the events, values associated with respective event attributes of a list of event attributes; and
a journey outcome;
wherein the training data process comprises generating a vector embedding for each of the events included within a given one of the journey data samples that captures the value for each of the event attributes by:
dividing the event attributes of the list of event attributes into a low cardinality group and a high cardinality group, wherein the dividing is done according to whether the values included within the training data samples for a given event attribute has a cardinality above or below a predefined cardinality threshold;
for each of the low cardinality groups, categorically encoding the values included within the low cardinality group according to a total number of unique values appearing therein;
for each of the high cardinality groups:
clustering the values included within the high cardinality group to create a plurality of cluster groups; and
categorically encoding the values included within the high cardinality group according to the plurality of cluster groups in which the value resides;
deeming that each of the training data samples includes:
a sequence of the vector embeddings generated from the sequence of events included in an associated one of the journey samples; and
the journey outcome of the associated one of the journey samples;
training a machine learning model using the generated training data samples, wherein:
an input of the machine learning model, for each training data sample, comprises the sequence of the vector embeddings; and
an output of the machine learning model, for each training data sample, comprises the associated journey outcome.

2. The computer-implemented method of claim 1, wherein the events comprise web events, each web event comprising an actions taken by a customer as the customer interacts with a website of a business, including actions related to selecting particular webpages of the website for browsing and submitting a search query.

3. The computer-implemented method of claim 2, wherein, when described in relation to a first training data sample, which is representative of how each of the training data samples are used to train the machine learning model, the step of training the machine learning model comprises:
providing as input to the machine learning model the sequence of vector embeddings generated for the first training data sample;
generating as output of the machine learning model a predicted journey outcome;
comparing the journey outcome of the first training data sample to the predicted journey outcome and, via the comparison, determining a difference therebetween; and
adjusting parameters of the machine learning model to reduce the determined difference.

4. The computer-implemented method of claim 2, wherein the journey outcome comprises data indicating whether a binary condition is achieved or not achieved, the binary condition relating to a performance metric of the business.

5. The computer-implemented method of claim 4, wherein the list of event attributes comprise:
multiple attributes describing the webpage being browsed by the customer, including at least a URL address and keywords associated therewith;
multiple attributes describing the customer, including at least a customer identifier, a location of the customer, and an attribute describing a device of the customer;
multiple attributes describing a referring website, including at least key words associated with the referring website;
at least one attribute describing a search query submitted by the customer on the referring website or the website of the business; and
at least one attribute describing a total number of events in a browsing session.

6. The computer-implemented method of claim 4, wherein, using one or more other trained machine learning models, the step of clustering the values included within each of the high cardinality groups comprises:
extracting features from the values included within the high cardinality group;
generating a vector embedding for the extracted features for each of the values;
clustering according to similarities found in the generated vector embeddings.

7. The computer-implemented method of claim 6, wherein the machine learning model comprises a transformer model.

8. The computer-implemented method of claim 6, wherein the machine learning model comprises an attention-based bidirectional long short-term memory recurrent neural network that calculates attention scores for respective events included within a customer journey when predicting a journey outcome.

9. The computer-implemented method of claim 8, further comprising the step of determining milestone events by:
receiving an attention score threshold;
receiving a subset of training data samples, the subset of training data samples including training data samples in which the trained machine learning model accurately predicts whether the binary condition is achieved or not achieved;
determining the attention scores for the events included within each of the training date samples of the subset of training data samples;
for each of the events, comparing the attention scores to the attention score threshold;
determining whether each of the events comprises a milestone event based on whether the attention score for the event exceeds the attention score threshold; and
identifying a customer journey type as being a sequence of the determined milestone events.

10. The computer-implemented method of claim 9, further comprising the step of generating a visual representation of the identified customer journey type, the visual representation comprising a sequence of connected nodes where each of the nodes is labeled as being one of the milestone events of the customer journey type.

11. The computer-implemented method of claim 10, wherein the generated visual representation includes volume and direction of traffic labeling from one of the milestone events to another of the milestone events.

12. The computer-implemented method of claim 11, wherein the step of receiving the attention score threshold includes receiving a plurality of different attention score thresholds so to generate a plurality of respective customer journey types, the plurality of customer journey types having varying number of the identified milestone events in accordance with the plurality of different attention score thresholds.

13. The computer-implemented method of claim 12, further comprising the step of generating the visual representations of each of the plural of customer journey types.

14. The computer-implemented method of claim 9, further comprising the step of:
correlating high attention scores achieved in determining the milestone events with one or more particular event attributes present in the milestone events.

15. The computer-implemented method of claim 14, further comprising the step of:
outputting one or more recommendations regarding actions to take with a future customer interacting with the website of the business when the one or more particular event attributes are detected as being present during the interaction with the future customer.

16. The computer-implemented method of claim 15, further comprising the step of:
determining one or more other particular event attributes that comprise noise based on a low correlation in determining the milestone events;
outputting one or more recommendations regarding removing the one or more other particular event attributes when training a revised version of the machine learning model.

17. A system comprising:
a processor; and
a memory storing instructions which, when executed by the processor, cause the processor to perform the steps of:
generating, via a training data process, training data samples from respective journey data samples, each of the journey data samples comprising a customer journey as represented by data describing:
a sequence of events;
for each of the events, values associated with respective event attributes of a list of event attributes; and
a journey outcome;
wherein the training data process comprises generating a vector embedding for each of the events included within a given one of the journey data samples that captures the value for each of the event attributes by:
dividing the event attributes of the list of event attributes into a low cardinality group and a high cardinality group, wherein the dividing is done according to whether the values included within the training data samples for a given event attribute has a cardinality above or below a predefined cardinality threshold;
for each of the low cardinality groups, categorically encoding the values included within the low cardinality group according to a total number of unique values appearing therein;
for each of the high cardinality groups:
clustering the values included within the high cardinality group to create a plurality of cluster groups; and
categorically encoding the values included within the high cardinality group according to the plurality of cluster groups in which the value resides;
deeming that each of the training data samples includes:
a sequence of the vector embeddings generated from the sequence of events included in an associated one of the journey samples; and
the journey outcome of the associated one of the journey samples;
training a machine learning model using the generated training data samples, wherein:
an input of the machine learning model, for each training data sample, comprises the sequence of the vector embeddings; and
an output of the machine learning model, for each training data sample, comprises the associated journey outcome.

18. The system of claim 17, wherein the events comprise web events, each web event comprising an actions taken by a customer as the customer interacts with a website of a business, including actions related to selecting particular webpages of the website for browsing and submitting a search query.

19. The system of claim 18, wherein the machine learning model comprises an attention-based bidirectional long short-term memory recurrent neural network that calculates attention scores for respective events included within a customer journey when predicting a journey outcome; and
wherein the memory stores further instructions that, when executed by the processor, cause the processor to perform the steps of:
determining milestone events by:
receiving an attention score threshold;
receiving a subset of training data samples, the subset of training data samples including training data samples in which the trained machine learning model accurately predicts whether the binary condition is achieved or not achieved;
determining the attention scores for the events included within each of the training date samples of the subset of training data samples;
for each of the events, comparing the attention scores to the attention score threshold;
determining whether each of the events comprises a milestone event based on whether the attention score for the event exceeds the attention score threshold; and
identifying a customer journey type as being a sequence of the determined milestone events.

20. The system of claim 19, wherein the memory stores further instructions that, when executed by the processor, cause the processor to perform the steps of:
generating a visual representation of the identified customer journey type, the visual representation comprising a sequence of connected nodes where each of the nodes is labeled as being one of the milestone events of the customer journey type.
